(19) United States
(12) Patent Application Publication
(10) Pub. No.: US 2026/0215992 A1
(43) Pub. Date: Jul. 30, 2026

(54) FOOTREST APPARATUS

(71) Applicants: Linda L. Tanner-Johnson, Las Vegas, NV (US); Derrick M. Johnson, Las Vegas, NV (US)

(72) Inventors: Linda L. Tanner-Johnson, Las Vegas, NV (US); Derrick M. Johnson, Las Vegas, NV (US)

(21) Appl. No.: 19/183,296

(22) Filed: Apr. 18, 2025

Related U.S. Application Data
(60) Provisional application No. 63/711,276, filed on Oct. 24, 2024.

(51) Int. Cl. A61H 3/04

(52) U.S. Cl. CPC A61H 3/04; A61H 2201/1633; A61H 2201/164

(57) ABSTRACT

Systems and devices to enhance user comfort and support when seated in assistive mobility aids, such as rollator devices, are described herein, specifically, a footrest apparatus. The systems and devices herein cater to the unique requirements of individuals relying on mobility aids as well as caregivers.

### CROSS-REFERENCE TO RELATED APPLICATIONS

This application is a non-provisional and claims benefit of U.S. Provisional Application No. 63/711,276 filed Oct. 24, 2024, the specification of which is incorporated herein in its entirety by reference.

### FIELD OF THE INVENTION

The present invention features systems and devices (e.g., a footrest apparatus) designed to provide support to a user's feet during seated periods, such as when using a rollator or a similar mobility device.

### BACKGROUND OF THE INVENTION

Rollators have transformed the mobility of countless individuals, providing essential support and fostering independence in their daily lives. These four-wheeled walking aids offer not only stability but also convenience, often featuring a built-in seat for moments of rest. However, one conspicuous absence in many conventional rollators is a footrest. This absence can present challenges and discomfort, especially during prolonged use. The integration of a footrest into a rollator represents a significant enhancement to the overall mobility experience, significantly improving the comfort and utility of these devices. Beyond providing added comfort during seated breaks, a footrest also plays a pivotal role in assisting caregivers or assistants. A footrest may make maneuvering the rollator more effortless, ensuring that users can be easily pushed and supported, thereby enhancing both the user's comfort and the caregiver's ease of use.

In response to this need for enhanced functionality and user comfort, the present invention features a footrest apparatus that seamlessly integrates into the rollator's frame, offering a holistic solution to the challenges users may face during mobility while making it more accessible and convenient for caregivers and assistants. As compared to prior solutions, which are largely based around foldout pedal designs, the present invention provides a footrest bar, which is more easily adapted for compatibility with a wider range of rollator devices and which is stowable in a more compact configuration when not in use. The present invention, therefore, offers a footrest solution that is broadly adaptable to a wide range of rollator devices and which is lightweight, convenient, and simple to use as compared to prior solutions.

### BRIEF SUMMARY OF THE INVENTION

It is an objective of the present invention to provide systems and devices that support a user's feet when sitting, e.g., in a rollator device, as specified in the independent claims. Embodiments of the invention are given in the dependent claims. Embodiments of the present invention can be freely combined with each other if they are not mutually exclusive.

In some embodiments, the present invention features a retractable footrest system. The system may comprise a) a first mounting bracket comprising a first end, a second end opposite the first end, a third side, and a horizontal component extending from the third side between the first end and the second end; wherein the first end comprises an attachment component; b) a bar comprising a first end and a second end, wherein the first end is pivotably connected to the horizontal component of the first mounting bracket; and c) a second mounting bracket comprising a first end, a second end opposite the first end, and a horizontal component extending from the first end. In some embodiments, the second end of the bar is configured to extend and connect the first mounting bracket and the second mounting bracket.

One of the unique and inventive technical features of the present invention is the implementation of a retractable footrest bar on an attachment for a mobility device. Without wishing to limit the invention to any theory or mechanism, it is believed that the technical feature of the present invention advantageously provides for the use of any mobility device as a tool for walking assistance as well as a short-term wheelchair suitable for smooth surfaces. None of the presently known prior references or works have the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

The features and advantages of the present invention will become apparent from a consideration of the following detailed description presented in connection with the accompanying drawings in which:

FIG. 1 shows a non-limiting example of the first mounting bracket mounted to a first side of a frame of a rollator device.

FIG. 2A-2C shows various viewpoints of the second mounting bracket mounted to the second side of the frame of the rollator device.

FIG. 3A-3D shows the retractable footrest system described herein being set up. In some embodiments, to set up the retractable footrest system, the bar is removed from the attachment component and pivoted downward towards the second end of the first mounting bracket. Then, the bar is extended horizontally until the pin disposed on the second end of the bar is able to engage the hole disposed through the horizontal component of the second mounting bracket.

FIG. 4 shows a close-up view of the pin disposed on the second end of the bar and the hole disposed through the horizontal component of the second mounting bracket.

FIG. 5A-5C shows the first mounting bracket, the second mounting bracket, and the bar, along with other components that may be used to attach the mounting brackets to the frame of a rollator device of the like.

FIG. 6A-6D shows various angles of the first mounting bracket and the second mounting bracket.

FIG. 7A-7C shows various angles of the notches disposed at or near the second end of the first and second mounting bracket.

FIG. 8 shows an exploded view of an embodiment of the bar of the present invention.

FIG. 9A shows an isometric view of a first bar segment of the bar of the present invention.

FIG. 9B shows a side view of the first bar segment of the bar of the present invention.

FIG. 9C shows a front view of the first bar segment of the bar of the present invention.

FIG. 10A shows an isometric view of a second bar segment of the bar of the present invention.

FIG. 10B shows a side view of the second bar segment of the bar of the present invention.

FIG. 10C shows a front view of the second bar segment of the bar of the present invention.

FIG. 11A shows an isometric view of a stop lock of the bar of the present invention.

FIG. 11B shows a front view of the stop lock of the bar of the present invention.

FIG. 11C shows a side view of the stop lock of the bar of the present invention.

FIG. 11D shows a back view of the stop lock of the bar of the present invention.

FIG. 12A shows an isometric view of a pin of the bar of the present invention.

FIG. 12B shows a side view of the pin of the bar of the present invention.

FIG. 12C shows a front view of the pin of the bar of the present invention.

FIG. 13A shows a cross-sectional view of an end cap of the bar of the present invention.

FIG. 13B shows an isometric view of the end cap of the bar of the present invention.

FIG. 13C shows a front view of the end cap of the bar of the present invention.

FIG. 13D shows a side view of the end cap of the bar of the present invention.

FIG. 13E shows a back view of the end cap of the bar of the present invention.

FIG. 14A shows an isometric view of a stop cap of the bar of the present invention.

FIG. 14B shows a top view of the stop cap of the bar of the present invention.

FIG. 14C shows a side view of the stop cap of the bar of the present invention.

FIG. 14D shows a bottom view of the stop cap of the bar of the present invention.

FIG. 15 shows a view of the bar of the present invention in a compressed configuration.

FIG. 16 shows a close-up view of a first end of the bar of the present invention.

FIG. 17 shows a close-up view of a second end of the bar of the present invention.

FIG. 18 shows a front view of the first end of the bar of the present invention.

FIG. 19 shows a second close-up view of the second end of the bar of the present invention.

FIG. 20 shows a view of the bar of the present invention in an extended configuration.

FIG. 21A shows a top view of an embodiment of the second mounting bracket of the present invention.

FIG. 21B shows a side view of an embodiment of the second mounting bracket of the present invention.

FIG. 21C shows another top view of an embodiment of the second mounting bracket of the present invention.

FIG. 21D shows an isometric view of an embodiment of the second mounting bracket of the present invention.

FIG. 22A shows a side view of an embodiment of the first mounting bracket of the present invention.

FIG. 22B shows a front view of an embodiment of the first mounting bracket of the present invention.

FIG. 22C shows another side view of an embodiment of the first mounting bracket of the present invention.

FIG. 22D shows a back view of an embodiment of the first mounting bracket of the present invention.

FIG. 22E shows another front view of an embodiment of the first mounting bracket of the present invention.

FIG. 23A shows an embodiment of the second mounting bracket of the present invention attached to a mobility device.

FIG. 23B shows another view of an embodiment of the second mounting bracket of the present invention attached to a mobility device.

FIG. 23C shows an embodiment of the first mounting bracket of the present invention attached to a mobility device.

FIG. 23D shows the first mounting bracket securing the rod of the present invention in a retracted configuration.

FIG. 23E shows a close-up view of the first mounting bracket securing the rod of the present invention in a retracted configuration.

FIG. 23F shows another close-up view of the first mounting bracket securing the rod of the present invention in a retracted configuration.

FIG. 23G shows an additional close-up view of the first mounting bracket securing the rod of the present invention in a retracted configuration.

FIG. 24A shows the rod of the present invention in a retracted configuration.

FIG. 24B shows the rod of the present invention in the process of entering an extended configuration.

FIG. 24C shows the rod of the present invention in an extended configuration.

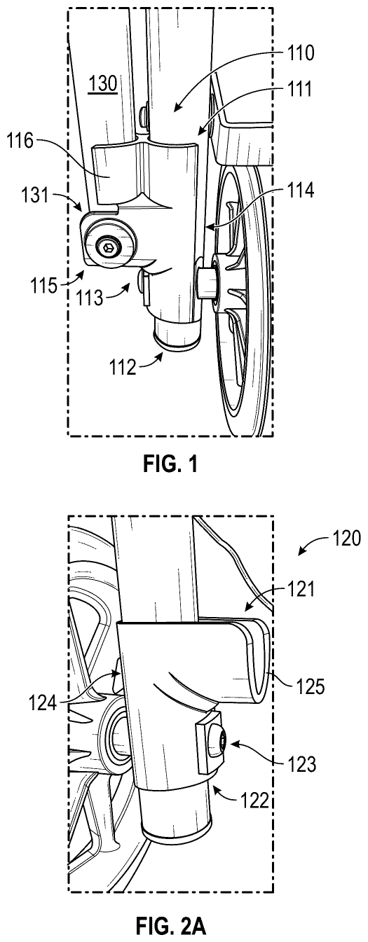

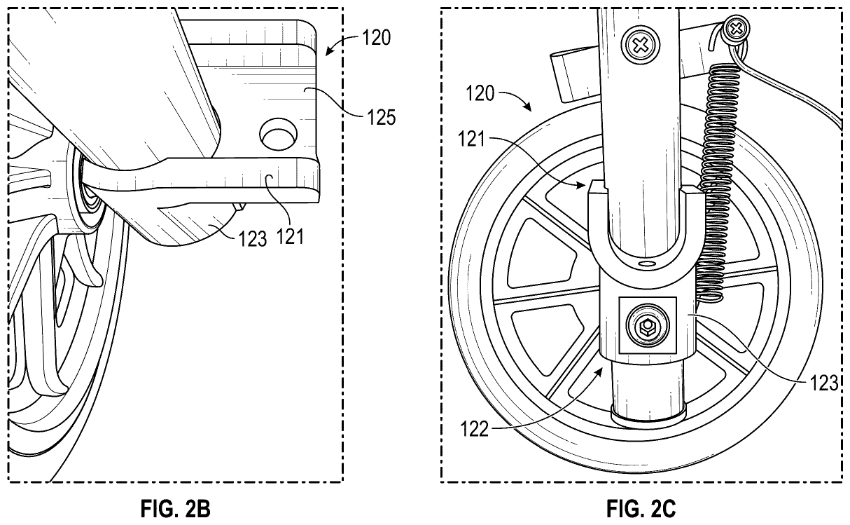

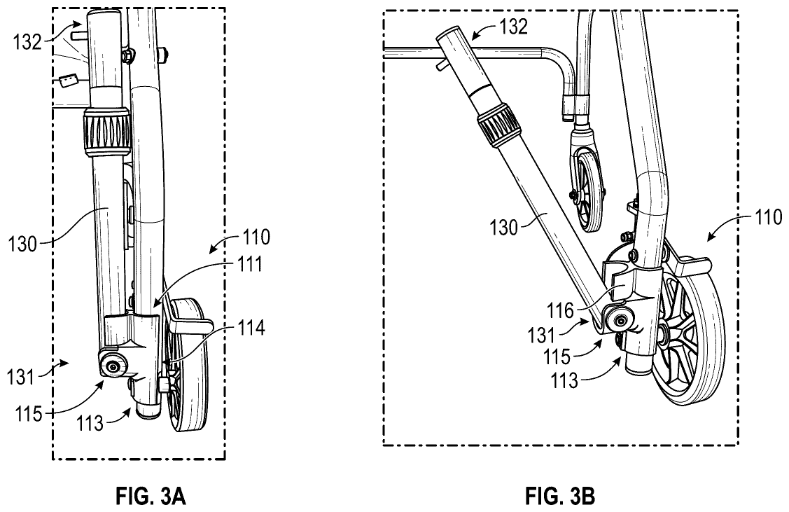

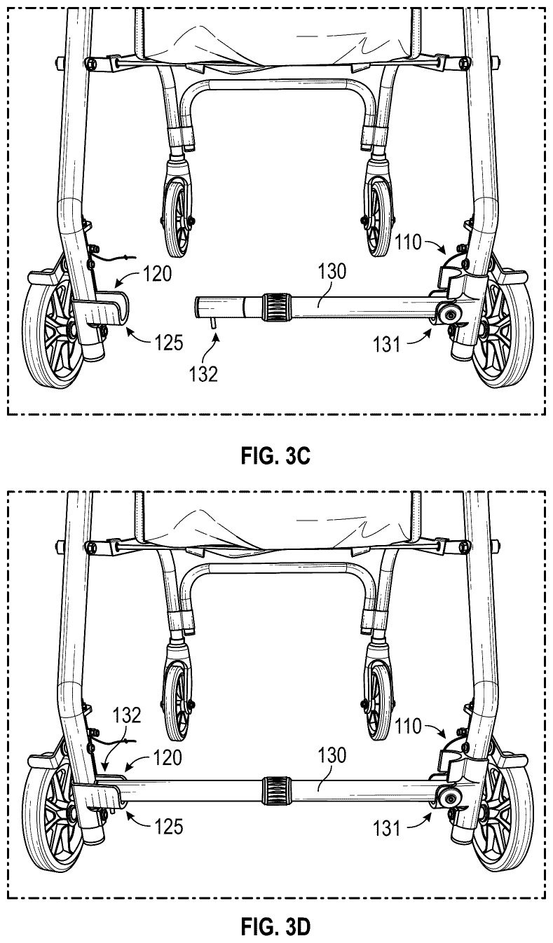

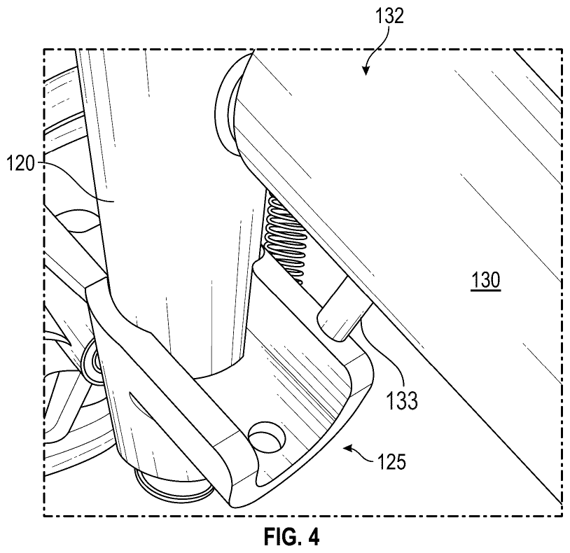

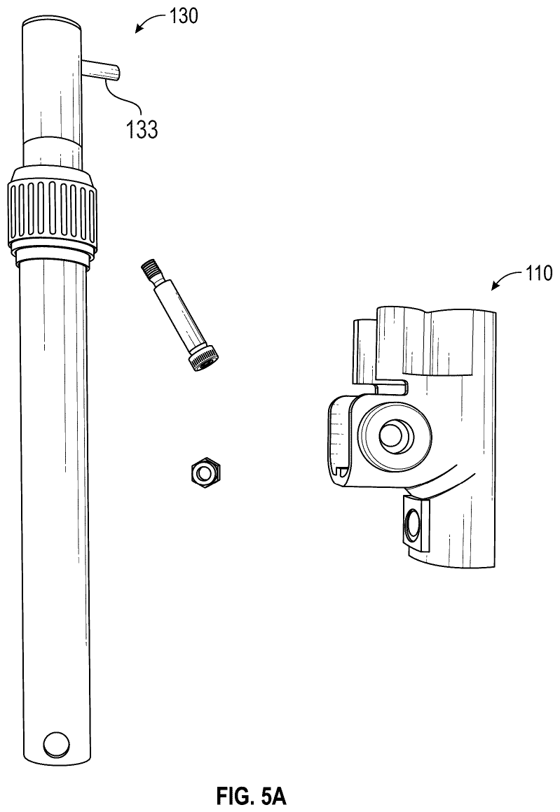

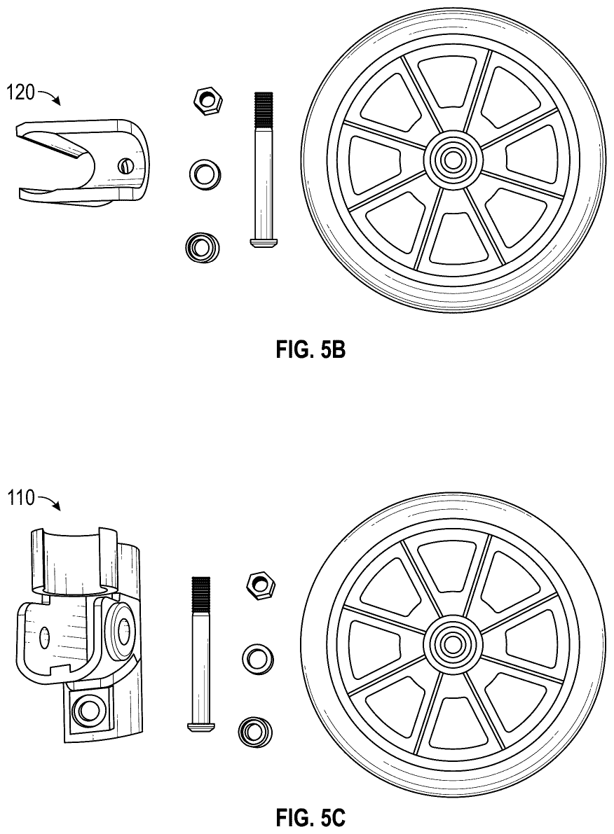

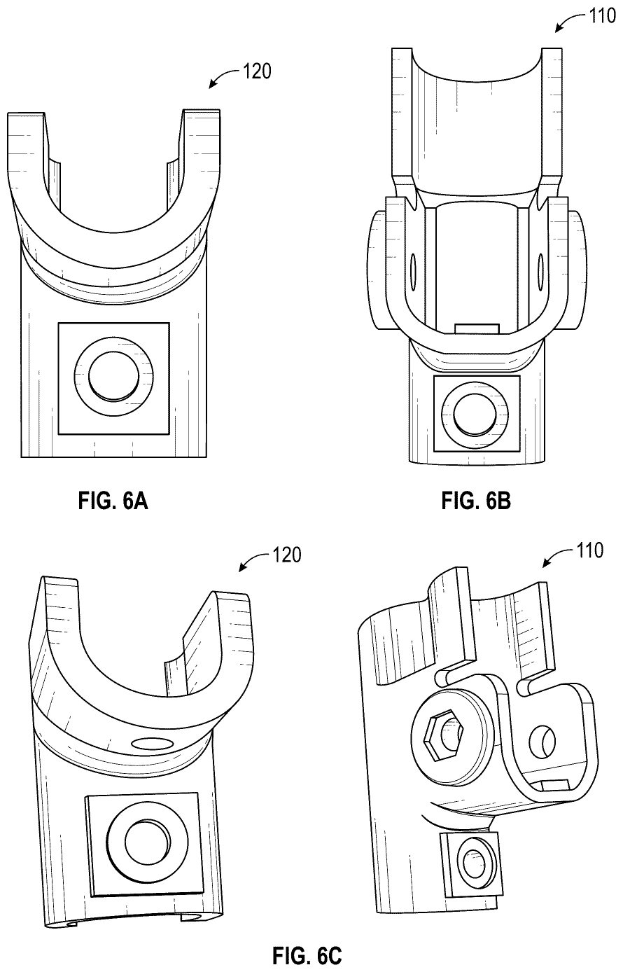

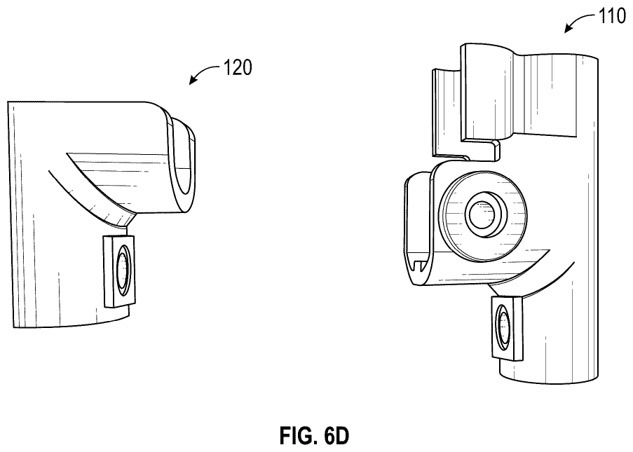

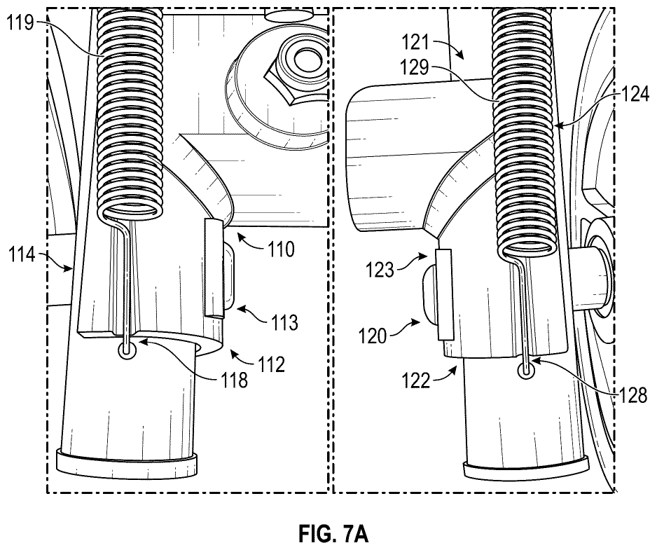

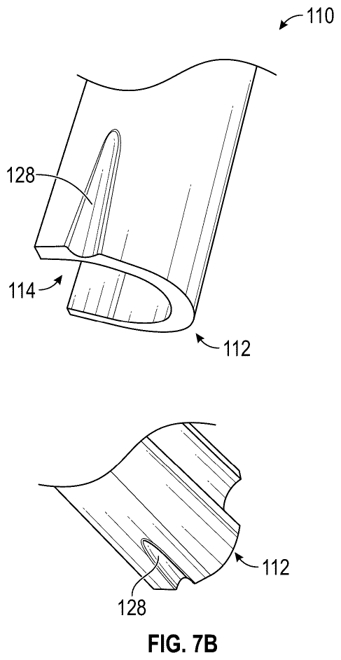

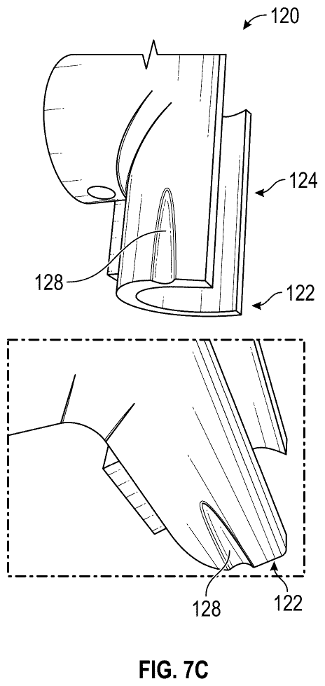

### DETAILED DESCRIPTION OF THE INVENTION

Following is a list of elements corresponding to a particular element referred to herein:
100 Retractable Footrest System
110 First Mounting Bracket
111 First End
112 Second End
113 Third Side
114 Fourth Side
115 Horizontal Component
116 Attachment Component
118 Notch
119 Spring
120 Second Mounting Bracket
121 First End
122 Second End
123 Third Side
124 Fourth Side
125 Horizontal Component
128 Notch
129 Spring
130 Bar
131 First End
132 Second End
133 Pin
134 Stop Lock
135 First Bar Segment
136 Second Bar Segment
137 End Cap
138 Stop Cap

The present invention features a retractable footrest system (100). The system (100) may comprise a first mounting bracket (110) comprising a first end (111), a second end (112) opposite the first end (111), a third side (113), and a horizontal component (115) extending from the third side (113) between the first end (111) and the second end (112). The system (100) may further comprise a bar (130) comprising a first end (131) and a second end (132). The system (100) may further comprise a second mounting bracket (120) comprising a first end (121), a second end (122) opposite the first end (121), and a horizontal component (125) extending from the first end (121). The first end (111) of the first mounting bracket (110) may further comprise an attachment component (116). In some embodiments, the first end (131) of the bar (130) is pivotably connected to the horizontal component (115) of the first mounting bracket (110). The second end (132) of the bar (130) is configured to extend and connect the first mounting bracket (110) and the second mounting bracket (120). When not extended between the first mounting bracket (110) and the second mounting bracket (120), the bar (130) may be secured, e.g., to a frame of a mobility device (e.g., a rollator), using the attachment component (116) on the first mounting bracket (110).

In some embodiments, the first mounting bracket (110) further comprises a fourth side (114). The fourth side (114) of the first mounting bracket (110) may comprise a concave inner surface configured to engage with the first side of a mobility device (e.g., a rollator) frame. In some embodiments, the second mounting bracket (120) further comprises a fourth side (124). The fourth side (124) of the second mounting bracket (120) may comprise a concave inner surface configured to engage with the second side of a mobility device (e.g., a rollator) frame. The first mounting bracket (110) may be disposed on the first side of a mobility device (e.g., a rollator) frame, and the second mounting bracket (120) may be disposed on the second side of a mobility device (e.g., a rollator) frame, such that the horizontal components (115, 125, respectively) face each other.

In some embodiments, the first mounting bracket (110) comprises a hole disposed through the third side (113) to the fourth side (114) at or near the second end (112) of the first mounting bracket (110). In some embodiments, the second mounting bracket (120) comprises a hole disposed through a third side (123) to a fourth side (124) at or near the second end (122) of the second mounting bracket (120). The aforementioned holes may be used to attach the mounting brackets to the mobility device (e.g., a rollator). In some embodiments, the bar (130) comprises a telescoping bar. The bar (130) may further comprise a pin (133) disposed at or near the second end (132) of the bar (130). In some embodiments, the bar (130) comprises a clasp component thereon to lock the bar (130) at a particular length, e.g., when extended or contracted.

In some embodiments, the horizontal component (125) of the second mounting bracket (120) comprises a concave inner surface. The horizontal component (125) of the second mounting bracket (120) may comprise a hole disposed through the inner surface to an exterior surface of the horizontal component (125). In some embodiments, the hole disposed through the inner surface to an exterior surface of the horizontal component (125) is configured to accommodate the pin (133) disposed at or near the second end (132) of the bar (130). In some embodiments, the fourth side (114) of the first mounting bracket (110) comprises a concave surface configured to engage with the first side of the frame of the rollator device. In some embodiments, the fourth side (124) of the second mounting bracket (120) comprises a concave surface configured to engage with a second side of the frame of the rollator device.

In some embodiments, the present invention features a retractable footrest system (100) configured to be attached to a mobility device. In some embodiments, the system (100) comprises a first mounting bracket (110) comprising a first end (111), a second end (112) opposite the first end (111), a third side (113), and a horizontal component (115) extending from the third side (113) between the first end (111) and the second end (112). In some embodiments, the first end (111) comprises an attachment component (116). In some embodiments, the present invention features a bar (130) comprising a first end (131) and a second end (132). In some embodiments, the first end (131) is pivotably connected to the horizontal component (115) of the first mounting bracket (110). In some embodiments, the present invention features a second mounting bracket (120) comprising a first end (121), a second end (122) opposite the first end (121), and a horizontal component (125) extending from the first end (121). In some embodiments, the second end (132) of the bar (130) is configured to extend and connect the first mounting bracket (110) and the second mounting bracket (120). In some embodiments, the bar (130) is configured to extend and retract upon user actuation. In some embodiments, the bar (130) in an extended configuration is configured to support a user's legs such that the mobility device is configured to transport the user in a seated position.

In some embodiments, the present invention features a retractable footrest system (100), wherein the first mounting bracket (110) further comprises a fourth side (114), wherein the fourth side (114) comprises a concave inner surface, wherein the concave inner surface of the fourth side (114) is configured to engage with a first side of a mobility device frame. In some embodiments, at least one of the first mounting bracket (110) and the second mounting bracket (120) are clampably engageable with at least one of a first side of a mobility device frame or a second side of a mobility device frame. In some embodiments, the mobility device is a rollator device.

In some embodiments, the first mounting bracket (110) comprises a hole disposed through the third side (113) to the fourth side (114) at or near the second end (112) of the first mounting bracket (110). In some embodiments, the bar (130) is configured to be secured using the attachment component (116). In some embodiments, the bar (130) comprises a telescoping bar. In some embodiments, the bar (130) comprises at least one of a serrated surface, a traction-increasing surface, a friction-increasing surface, or a grip-enhancing surface. In some embodiments, the bar (130) further comprises a pin (133) disposed at or near the second end (132) of the bar (130).

In some embodiments, the horizontal component (125) of the second mounting bracket (120) comprises a concave inner surface and a hole disposed through the inner surface to an exterior surface of the horizontal component (125). In some embodiments, the hole disposed through the inner surface to an exterior surface of the horizontal component (125) is configured to accommodate the pin (133) disposed at or near the second end (132) of the bar (130). In some embodiments, the second mounting bracket (120) further comprises a fourth side (124), wherein the fourth side (124) comprises a concave inner surface, wherein the concave inner surface of the fourth side (124) is configured to engage with a second side of a mobility device frame. In some embodiments, the second mounting bracket (120) comprises a hole disposed through the third side (123) to the fourth side (124) at or near the second end (122) of the second mounting bracket (120).

In some embodiments, the first mounting bracket (110) further comprises a notch (118) disposed at or near the second end (112) and near the fourth side (114) of the first mounting bracket (110). In some embodiments, the notch (118) disposed on the first mounting bracket (110) is configured to hold a spring (119). In some embodiments, the second mounting bracket (120) further comprises a notch (128) disposed at or near the second end (122) and near the fourth side (124) of the second mounting bracket (120). In some embodiments, the notch (128) disposed on the second mounting bracket (120) is configured to hold a spring (129). In some embodiments the present invention features a first mounting bracket (110) comprising an attachment component (116); a bar (130) comprising a first end (131) and a second end (132), wherein the first end (131) is pivotably connected to the first mounting bracket (110) and a second mounting bracket (120), wherein the second end (132) of the bar (130) is configured to extend and connect the first mounting bracket (110) and the second mounting bracket (120). In some embodiments, the bar (130) is configured to support a user's legs such that the mobility device is configured to transport the user in a seated position.

In some embodiments, the present invention features a first mounting bracket (110) comprising a first end (111), a second end (112) opposite the first end (111), a third side (113), and a horizontal component (115) extending from the third side (113) between the first end (111) and the second end (112) wherein the first end (111) comprises an attachment component (116). In some embodiments, the present invention features a bar (130) comprising a first end (131) and a second end (132), wherein the first end (131) is pivotably connected to the horizontal component (115) of the first mounting bracket (110). In some embodiments, the present invention features a second mounting bracket (120) comprising a first end (121), a second end (122) opposite the first end (121), and a horizontal component (125) extending from the first end (121), wherein the second end (132) of the bar (130) is configured to extend and connect the first mounting bracket (110) and the second mounting bracket (120).

In some embodiments, at least one of the first mounting bracket (110) and the second mounting bracket (120) are clampably engageable with at least one of a first side of a mobility device frame or a second side of a mobility device frame. In some embodiments, the bar (130) is configured to extend and retract upon user actuation. In some embodiments, the bar (130) in an extended configuration is configured to support a user's legs such that the rollator device is configured to transport the user in a seated position. In some embodiments, the bar (130) is configured to be secured using the attachment component (116). In some embodiments, the bar (130) comprises a telescoping bar comprising at least one of a serrated surface, a traction-increasing surface, a friction-increasing surface, or a grip-enhancing surface.

The present invention features a footrest system (100) configured to be attached to a mobility device. In some embodiments, the system (100) may comprise a first mounting bracket (110) comprising an attachment component (116). The system (100) may further comprise a bar (130) comprising a first end (131) and a second end (132). The first end (131) may be pivotably connected to the first mounting bracket (110). The system (100) may further comprise a second mounting bracket (120). The second end (132) of the bar (130) may be configured to extend and connect the first mounting bracket (110) and the second mounting bracket (120). The bar (130) may be configured to support a user's legs such that the mobility device is configured to transport the user in a seated position.

The present invention features a retractable footrest system (100) configured to be attached to a rollator device. In some embodiments, the system (100) may comprise a first mounting bracket (110) comprising a first end (111), a second end (112) opposite the first end (111), a third side (113), and a horizontal component (115) extending from the third side (113) between the first end (111) and the second end (112). The first end (111) may comprise an attachment component (116). The system (100) may further comprise a bar (130) comprising a first end (131) and a second end (132). The first end (131) may be pivotably connected to the horizontal component (115) of the first mounting bracket (110). The system (100) may further comprise a second mounting bracket (120) comprising a first end (121), a second end (122) opposite the first end (121), and a horizontal component (125) extending from the first end (121). The second end (132) of the bar (130) may be configured to extend and connect the first mounting bracket (110) and the second mounting bracket (120). At least one of the first mounting bracket (110) and the second mounting bracket (120) may be clampably engageable with at least one of a first side of a mobility device frame or a second side of a mobility device frame. The bar (130) may be configured to extend and retract upon user actuation. The bar (130) in an extended configuration may be configured to support a user's legs such that the rollator device is configured to transport the user in a seated position. The bar (130) may be configured to be secured using the attachment component (116). The bar (130) may comprise a telescoping bar comprising at least one of a serrated surface, a traction-increasing surface, a friction-increasing surface, or a grip-enhancing surface.

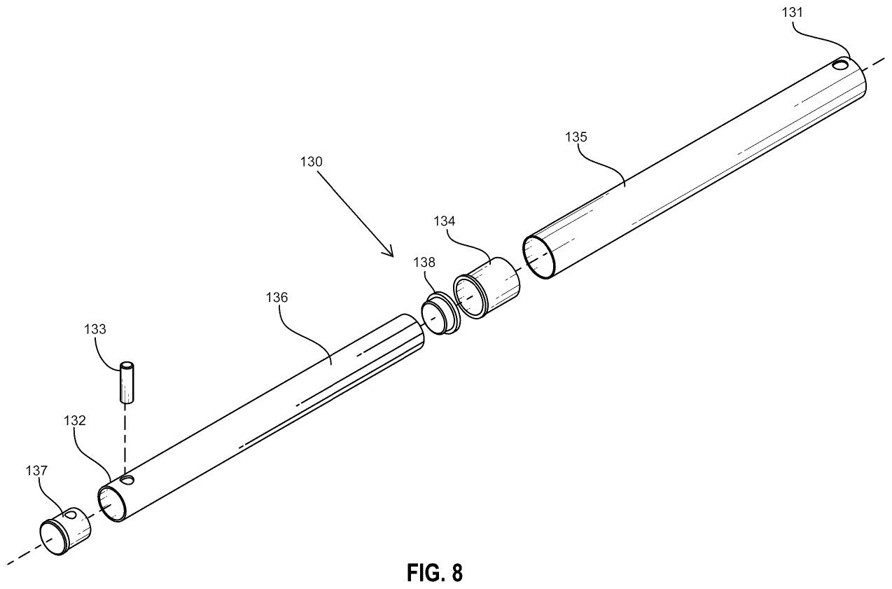

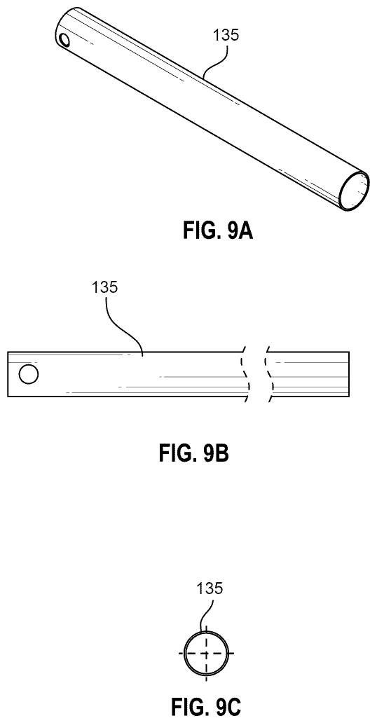

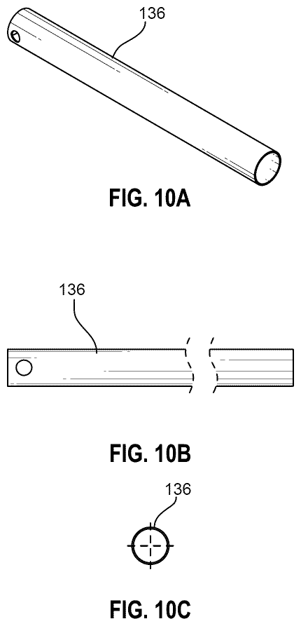

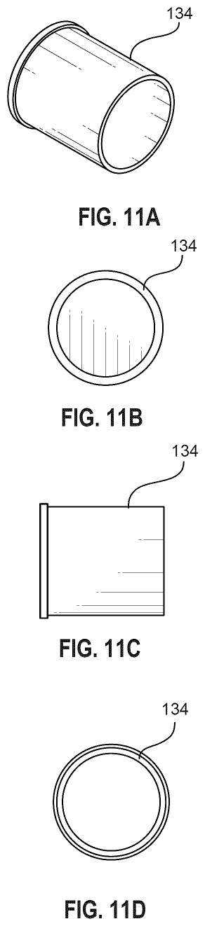

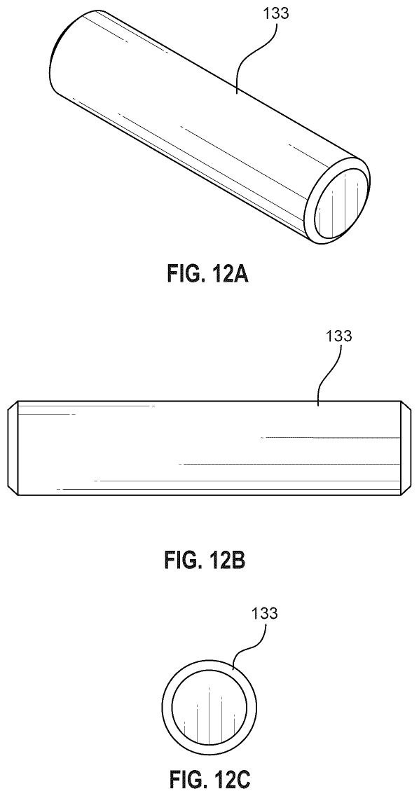

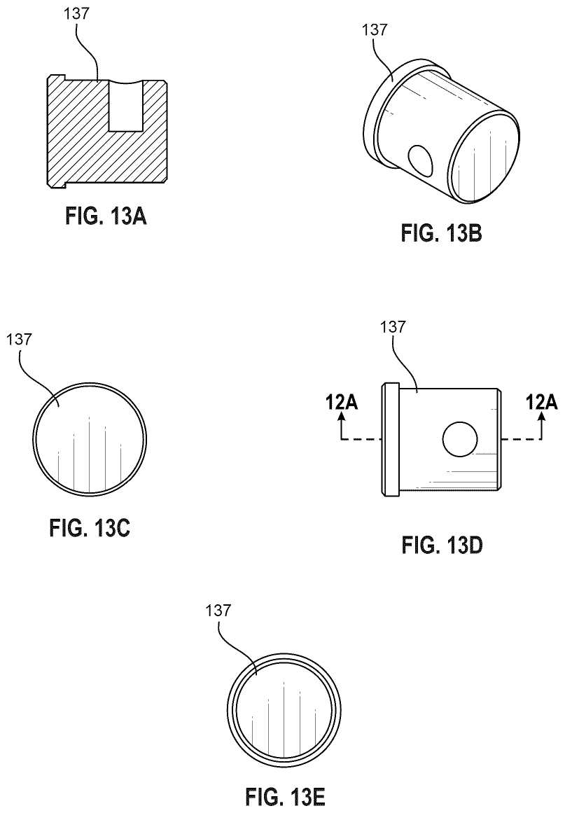

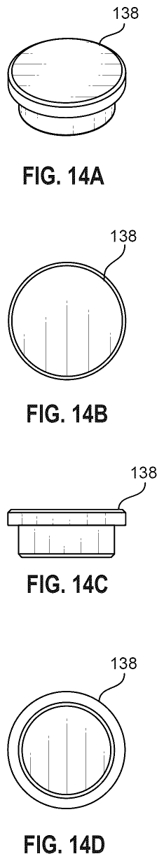

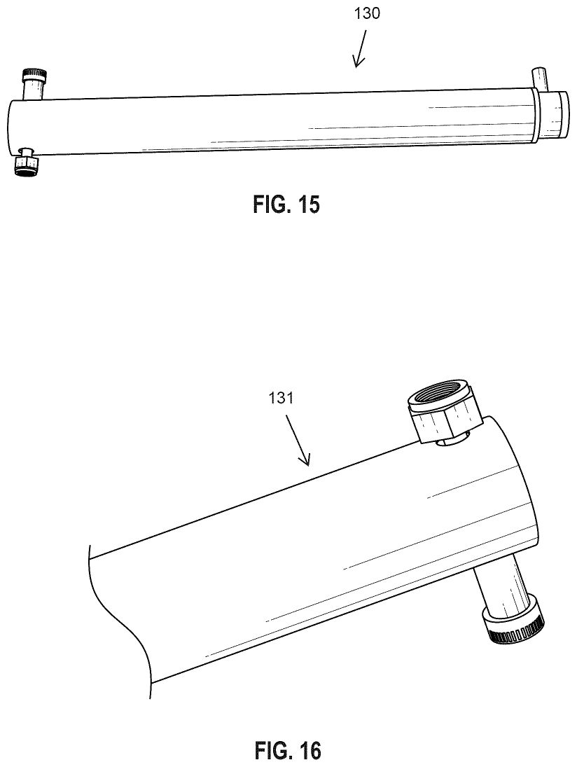

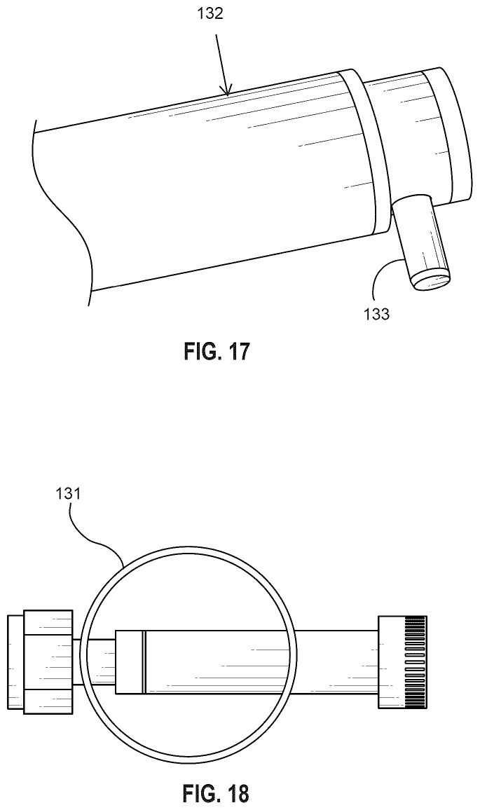

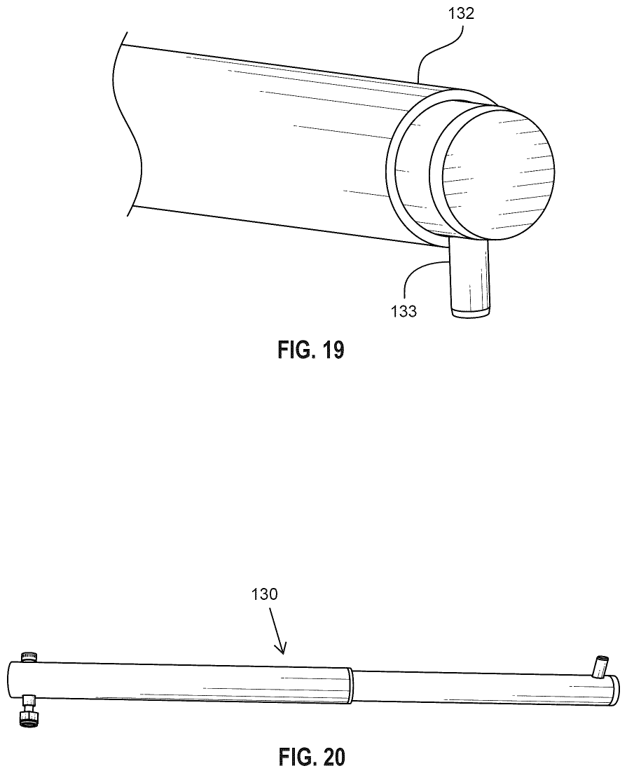

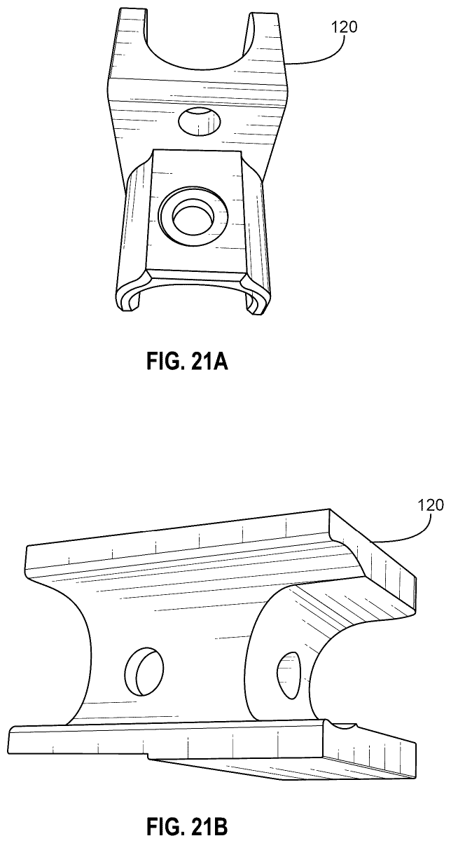

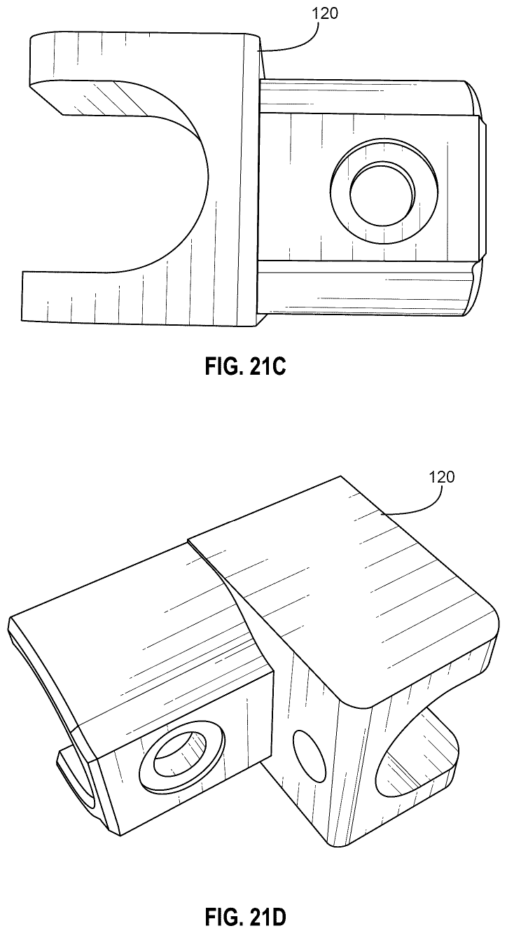

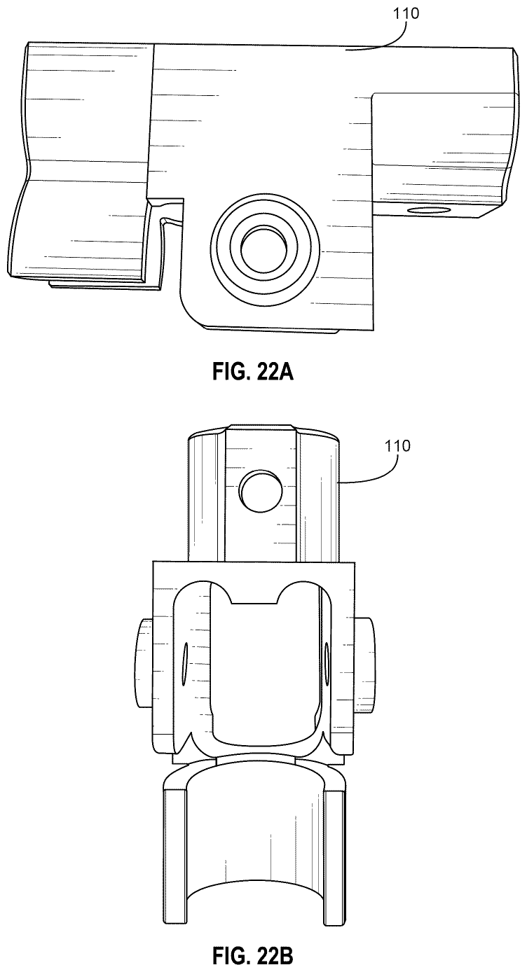

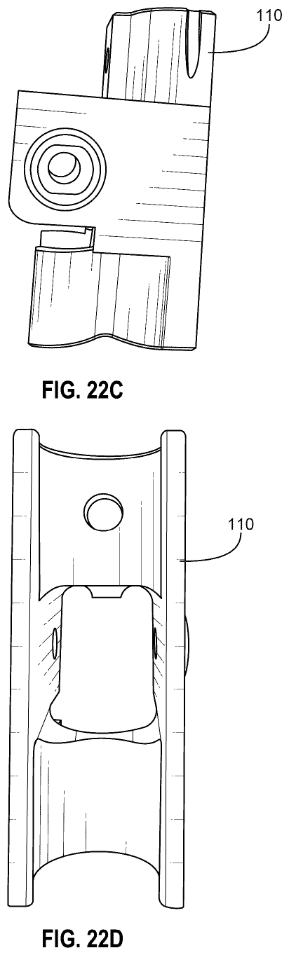

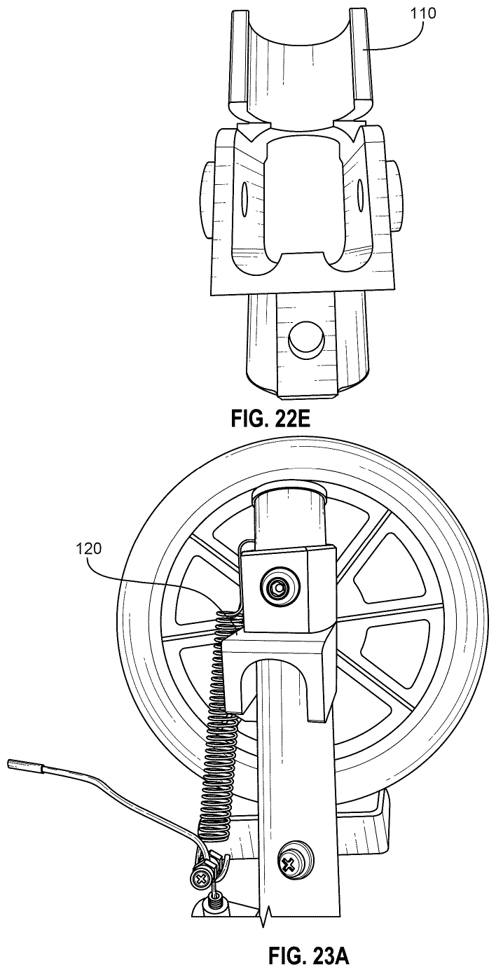

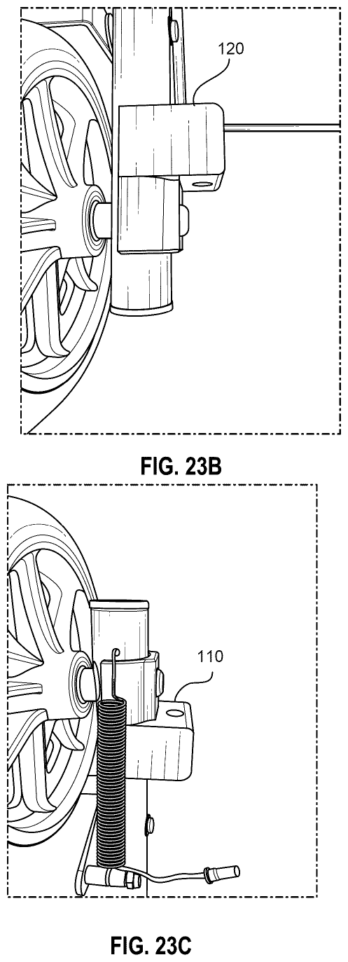

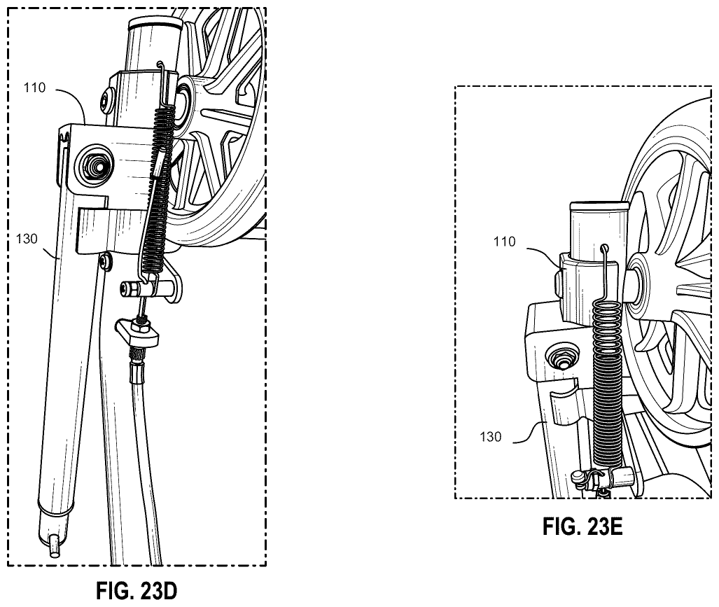

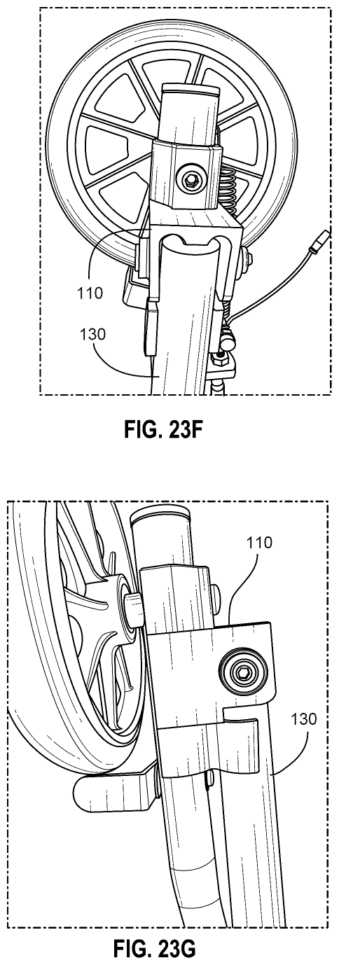

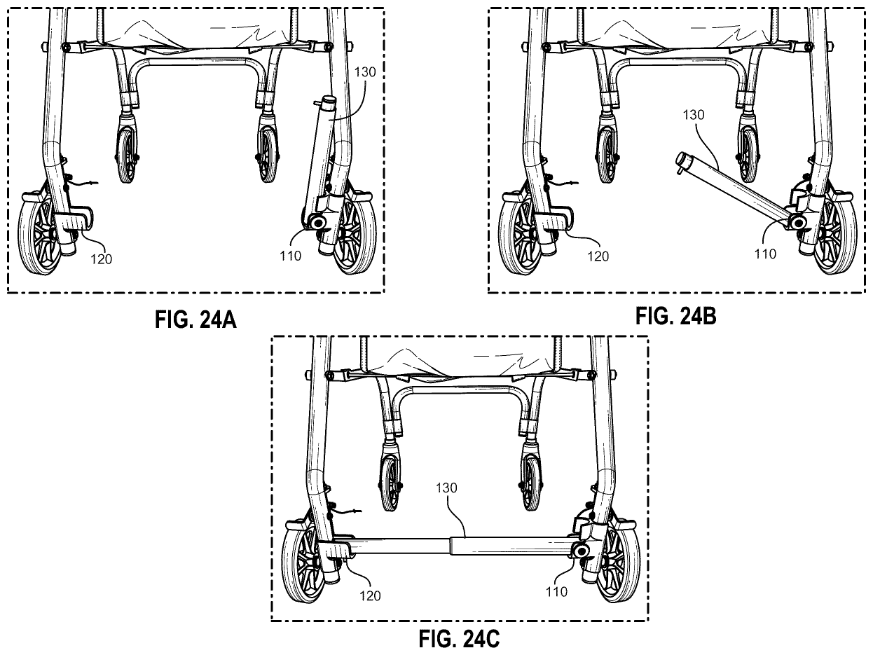

Referring now to FIGS. 8-20, the present invention features a bar configured to connect to pivot from a first bracket such that the bar can be pivoted into a retracted configuration or connected to a second bracket such that the bar is fixed in an extended configuration to act as a footstool. In some embodiments, the bar (130) may comprise a first end (131) and a second end (132). In some embodiments, the second end (132) of the bar (130) may comprise a hole suitable for accepting a pin (133). In some embodiments, the bar (130) may further comprise an end cap (137) secured in place by the pin (133). In some embodiments, the bar (130) may comprise a first bar segment (135) and a second bar segment (136). The first bar segment (135) and the second bar segment (136) may be telescopically coupled such that the second bar segment (136) fits into the first bar segment (135), allowing for transition from the retracted configuration to the extended configuration and vice versa. In some embodiments, the first bar segment (135) and the second bar segment (136) may be coupled by a stop lock mechanism comprising a stop lock (134) and a stop cap (138) configured to stop the second bar segment (136) from pulling out of the first bar segment (135) while locking it in place as the bar (130) enters the extended configuration. The stop lock mechanism may release upon the application of pressure to the second end (132) of the bar (130).

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A retractable footrest system (100) configured to be attached to a mobility device, the system (100) comprising:
a) a first mounting bracket (110) comprising a first end (111), a second end (112) opposite the first end (111), a third side (113), and a horizontal component (115) extending from the third side (113) between the first end (111) and the second end (112); wherein the first end (111) comprises an attachment component (116);
b) a bar (130) comprising a first end (131) and a second end (132), wherein the first end (131) is pivotably connected to the horizontal component (115) of the first mounting bracket (110); and
c) a second mounting bracket (120) comprising a first end (121), a second end (122) opposite the first end (121), and a horizontal component (125) extending from the first end (121), wherein the second end (132) of the bar (130) is configured to extend and connect the first mounting bracket (110) and the second mounting bracket (120);
wherein the bar (130) is configured to extend and retract upon user actuation;
wherein the bar (130) in an extended configuration is configured to support a user's legs such that the mobility device is configured to transport the user in a seated position.

2. The retractable footrest system (100) of claim 1, wherein the first mounting bracket (110) further comprises a fourth side (114), wherein the fourth side (114) comprises a concave inner surface, wherein the concave inner surface of the fourth side (114) is configured to engage with a first side of a mobility device frame.

3. The retractable footrest system (100) of claim 1, wherein at least one of the first mounting bracket (110) and the second mounting bracket (120) are clampably engageable with at least one of a first side of a mobility device frame or a second side of a mobility device frame.

4. The retractable footrest system (100) of claim 3, wherein the mobility device is a rollator device.

5. The retractable footrest system (100) of claim 1, wherein the first mounting bracket (110) comprises a hole disposed through the third side (113) to the fourth side (114) at or near the second end (112) of the first mounting bracket (110).

6. The retractable footrest system (100) of claim 1, wherein the bar (130) is configured to be secured using the attachment component (116).

7. The retractable footrest system (100) of claim 1, wherein the bar (130) comprises a telescoping bar.

8. The retractable footrest system (100) of claim 1, wherein the bar (130) comprises at least one of a serrated surface, a traction-increasing surface, a friction-increasing surface, or a grip-enhancing surface.

9. The retractable footrest system (100) of claim 1, wherein the bar (130) further comprises a pin (133) disposed at or near the second end (132) of the bar (130).

10. The retractable footrest system (100) of claim 9, wherein the horizontal component (125) of the second mounting bracket (120) comprises a concave inner surface and a hole disposed through the inner surface to an exterior surface of the horizontal component (125).

11. The retractable footrest system (100) of claim 10, wherein the hole disposed through the inner surface to an exterior surface of the horizontal component (125) is configured to accommodate the pin (133) disposed at or near the second end (132) of the bar (130).

12. The retractable footrest system (100) of claim 1, wherein the second mounting bracket (120) further comprises a fourth side (124), wherein the fourth side (124) comprises a concave inner surface, wherein the concave inner surface of the fourth side (124) is configured to engage with a second side of a mobility device frame.

13. The retractable footrest system (100) of claim 1, wherein the second mounting bracket (120) comprises a hole disposed through the third side (123) to the fourth side (124) at or near the second end (122) of the second mounting bracket (120).

14. The retractable footrest system (100) of claim 1, wherein the first mounting bracket (110) further comprises a notch (118) disposed at or near the second end (112) and near the fourth side (114) of the first mounting bracket (110).

15. The retractable footrest system (100) of claim 1, wherein the notch (118) disposed on the first mounting bracket (110) is configured to hold a spring (119).

16. The retractable footrest system (100) of claim 1, wherein the second mounting bracket (120) further comprises a notch (128) disposed at or near the second end (122) and near the fourth side (124) of the second mounting bracket (120).

17. The retractable footrest system (100) of claim 1, wherein the notch (128) disposed on the second mounting bracket (120) is configured to hold a spring (129).

18. A footrest system (100) configured to be attached to a mobility device, the system (100) comprising:
a) a first mounting bracket (110) comprising an attachment component (116);
b) a bar (130) comprising a first end (131) and a second end (132), wherein the first end (131) is pivotably connected to the first mounting bracket (110); and
c) a second mounting bracket (120), wherein the second end (132) of the bar (130) is configured to extend and connect the first mounting bracket (110) and the second mounting bracket (120);
wherein the bar (130) is configured to support a user's legs such that the mobility device is configured to transport the user in a seated position.

19. A retractable footrest system (100) configured to be attached to a rollator device, the system (100) comprising:
a) a first mounting bracket (110) comprising a first end (111), a second end (112) opposite the first end (111), a third side (113), and a horizontal component (115) extending from the third side (113) between the first end (111) and the second end (112); wherein the first end (111) comprises an attachment component (116);
b) a bar (130) comprising a first end (131) and a second end (132), wherein the first end (131) is pivotably connected to the horizontal component (115) of the first mounting bracket (110); and
c) a second mounting bracket (120) comprising a first end (121), a second end (122) opposite the first end (121), and a horizontal component (125) extending from the first end (121), wherein the second end (132) of the bar (130) is configured to extend and connect the first mounting bracket (110) and the second mounting bracket (120);
wherein at least one of the first mounting bracket (110) and the second mounting bracket (120) are clampably engageable with at least one of a first side of a mobility device frame or a second side of a mobility device frame;
wherein the bar (130) is configured to extend and retract upon user actuation;
wherein the bar (130) in an extended configuration is configured to support a user's legs such that the rollator device is configured to transport the user in a seated position;
wherein the bar (130) is configured to be secured using the attachment component (116); and
wherein the bar (130) comprises a telescoping bar comprising at least one of a serrated surface, a traction-increasing surface, a friction-increasing surface, or a grip-enhancing surface.
